(19) United States
(12) Patent Application Publication
(10) Pub. No.: US 2013/0038818 A1
(43) Pub. Date: Feb. 14, 2013

(54) DISPLAY DEVICE, METHOD OF MANUFACTURING THE SAME, AND ELECTRONIC APPARATUS

(71) Applicants: Atsushi Toda, Kanagawa (JP); Teruo Hirayama, Kanagawa (JP)

(72) Inventors: Atsushi Toda, Kanagawa (JP); Teruo Hirayama, Kanagawa (JP)

(73) Assignee: SONY CORPORATION, Tokyo (JP)

(21) Appl. No.: 13/561,801

(22) Filed: Jul. 30, 2012

(30) Foreign Application Priority Data
Aug. 8, 2011 (JP) 2011-172745

(51) Int. Cl. H05B 33/14; H05B 33/10; G02F 1/13357; B82Y 20/00

(52) U.S. Cl. 349/69; 313/498; 445/58; 977/932

(57) ABSTRACT

A display device includes: a light source section that emits excitation light for each pixel; and a light emitting layer that includes a quantum dot and emits emission light for each of the pixels. The quantum dot generates, based on the excitation light, the emission light having a wavelength longer than a wavelength of the excitation light.

### BACKGROUND

The present disclosure relates to a display device that includes a light emitting layer containing quantum dots, a method of manufacturing the display device, and an electronic apparatus equipped with the display device.

Typically, liquid crystal display devices, organic-electro luminescence (EL) display devices, plasma display panel (PDP) devices, and the like are known as examples of display devices. In addition to these examples, currently, display devices that include a light emitting layer containing quantum dots are proposed (for example, see Japanese Unexamined Patent Application Publication No. 2010-156899).

### SUMMARY

In the above Japanese Unexamined Patent Application Publication No. 2010-156899, the display device containing quantum dots uses a laser light source, as a light source that emits excitation light. For display devices employing such a technique, the improvement of the utilization efficiency of the light is in demand. Accordingly, a proposal of a display device is desired, which facilitates the improvement of the utilization efficiency of light.

There is a need for a display device, a method of manufacturing the display device, and an electronic apparatus, capable of facilitating the improvement of the utilization efficiency of light.

A display device according to an embodiment of the present disclosure includes: a light source section emitting excitation light for each pixel; and a light emitting layer including a quantum dot and emitting emission light for each of the pixels, the quantum dot generating, based on the excitation light, the emission light having a wavelength longer than a wavelength of the excitation light.

A method of manufacturing a display device according to an embodiment of the present disclosure includes: forming a light source section that emits excitation light for each pixel; and forming, using a quantum dot, a light emitting layer that emits emission light for each of the pixels, the quantum dot being configured to generate, based on the excitation light, the emission light having a wavelength longer than a wavelength of the excitation light.

An electronic apparatus according to an embodiment of the present disclosure is provided with a display device. The display device includes: a light source section emitting excitation light for each pixel; and a light emitting layer including a quantum dot and emitting emission light for each of the pixels, the quantum dot generating, based on the excitation light, the emission light having a wavelength longer than a wavelength of the excitation light.

According to the display device, the method of manufacturing the display device, and the electronic apparatus of above respective embodiments of the present disclosure, the excitation light is emitted for each of the pixels by the light source section, and the emission light is emitted for each of the pixels by the light emitting layer that includes the quantum dot, based on the excitation light. The quantum dot generates, based on the excitation light, the emission light having a wavelength longer than a wavelength of the excitation light. This enables to make a wavelength conversion from the excitation light to the emission light with a simple configuration.

According to the display device, the method of manufacturing the display device, and the electronic apparatus of above respective embodiments of the present disclosure, the quantum dot included in the light emitting layer generate, based on the excitation light, the emission light having a wavelength longer than a wavelength of the excitation light. This makes it possible to make a wavelength conversion from the excitation light to the emission light with a simple configuration. Therefore, it is possible to facilitate the improvement of the utilization efficiency of light.

It is to be understood that both the foregoing general description and the following detailed description are exemplary, and are intended to provide further explanation of the technology as claimed.

### BRIEF DESCRIPTION OF THE DRAWINGS

The accompanying drawings are included to provide a further understanding of the disclosure, and are incorporated in and constitute a part of this specification. The drawings illustrate embodiments and, together with the specification, serve to explain the principles of the technology.

FIG. 1 is a schematic cross sectional view illustrating an exemplified configuration of a display device according to an embodiment of the present disclosure.

FIG. 2 is a schematic perspective view illustrating an exemplified, detailed configuration of a laser light source illustrated in FIG. 1.

FIG. 3 is a schematic cross sectional view illustrating an exemplified, detailed configuration of a light modulation element illustrated in FIG. 1.

FIG. 4 is a schematic perspective view illustrating an exemplified arrangement configuration of laser light sources, a light guide plate, and an incident side polarization plate.

FIGS. 5A and 5B are schematic plane views illustrating an exemplified relationship between polarization directions of laser light beams and a polarization axis of the incident side polarization plate.

Parts (A) to (C) of FIG. 6 are property diagrams depicting an exemplified relationship between a size and absorption spectrum of a quantum dot for respective materials thereof.

FIG. 7 is a schematic cross sectional view for explaining a basic operation of the display device illustrated in FIG. 1.

Parts (A) to (C) of FIG. 8 are schematic views for explaining an action of a quantum dot.

Parts (A) to (C) of FIG. 9 are property diagrams for explaining an action of a quantum dot.

Parts (A) and (B) of FIG. 10 are respective property diagrams which depict wavelength properties of excitation light and emission light according to Example and Comparative example.

FIG. 11 is a perspective view illustrating the appearance of application example 1 of the display device according to the embodiment.

FIGS. 12A and 12B are perspective views illustrating the appearances of application example 2 as viewed from a front side thereof and a back side thereof, respectively.

FIG. 13 is a perspective view illustrating the appearance of application example 3.

FIG. 14 is a perspective view illustrating the appearance of application example 4.

FIG. 15A is an elevation view of application example 5 in the opened state, FIG. 15B is a side view of the application example 5 illustrated in FIG. 15A, FIG. 15C is an elevation view of the application example 5 in the closed state, and FIG. 15D to 15G are a left side view, a right side view, a top view, and a bottom view of the application example 5 illustrated in FIG. 15C, respectively.

### DETAILED DESCRIPTION

Thereinafter, an embodiment of the present disclosure will be described in detail, with reference to the accompanying drawings. Note that a description will be given in the following order.

1. Embodiment (an example of using a semiconductor laser, a liquid crystal element, and multi-colored light emitting layers that contain quantum dots)
2. Application examples (examples of applying the display device to electronic apparatuses)
3. Modification examples

### Embodiment

### Configuration of Display Device 1

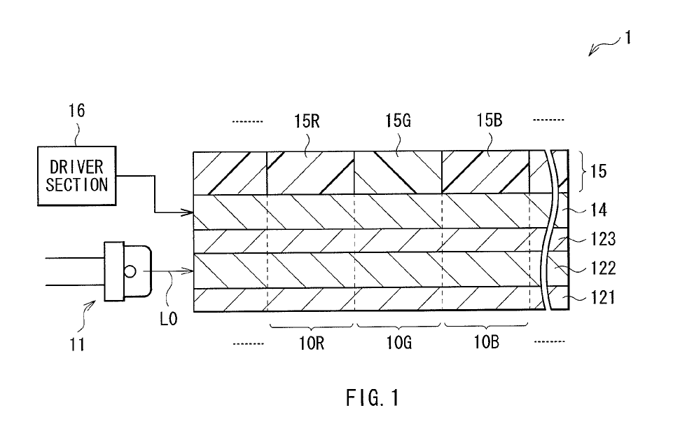

FIG. 1 schematically illustrates a cross sectional configuration of a display device (display device 1) according to one embodiment of the present disclosure. This display device 1 includes a laser light source 11, a reflection plate 121, a light guide plate 122, a diffuser plate 123, a light modulation element (liquid crystal element) 14, a light emitting layer (quantum dot containing layer) 15, and a driver section 16. Note that each of the reflection plate 121, the light guide plate 122, and the diffuser plate 123 serves as an optical member. Among all the above-mentioned components, the reflection plate 121, the light guide plate 122, the diffuser plate 123, the light modulation element 14, and the light emitting layer 15 are stacked in this order from the back surface to the viewing surface (display or front surface). Note that a combination of the laser light source 11, the reflection plate 121, the light guide plate 122, the diffuser plate 123, and the light modulation element 14 corresponds to one concrete example of a “light source section (that emits excitation light for each pixel)” according to an embodiment of the present disclosure.

### (Laser Light Source 11)

In an example illustrated in FIG. 1, the laser light source 11 is disposed on one side of the light guide plate 122, and is a light source that emits laser light L0, as excitation light, toward the light emitting layer 15 which will be described hereinafter. Any of various types of laser light sources may be used as this laser light source 11, but for example, it is preferable for a semiconductor laser to be used.

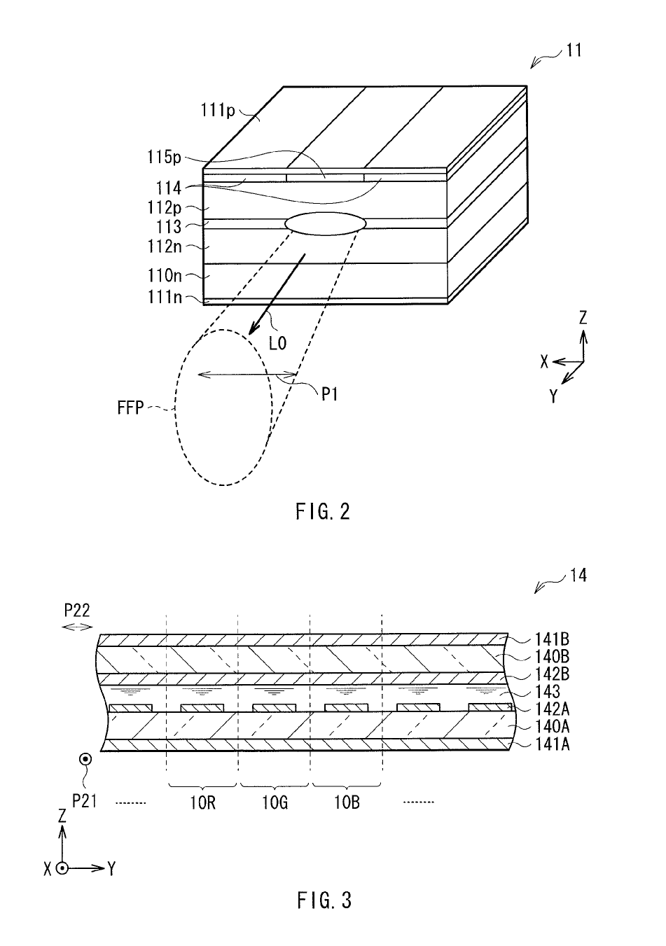

FIG. 2 is a schematic perspective view illustrating an exemplified, detailed configuration of the laser light source 11 that is formed of a semiconductor laser. In this semiconductor laser, an electrode 111n, an n-type substrate 110n, an n-type cladding layer 112n, an active layer 113, a p-type cladding layer 112p, an insulating layer 114, a p-type contact layer 115p, and an electrode 111p are stacked in this order along a Z axis illustrated in FIG. 2. Thus, this semiconductor laser has the so-called “double hetero (DH) structure”.

The electrode 111n is an electrode to which electrons serving as carriers are to be injected, and is made of, for example, a metal material such as AuGe alloy or the like. Meanwhile, the electrode 111p is an electrode to which holes serving as carriers are to be injected, and is made of, for example, a metal material such as Ti/Pt/Au or the like.

The n-type substrate 110n is a substrate made of a semiconductor material such as n-type gallium arsenide (n-GaAs) or the like.

The p-type contact layer 115p is a contact layer made of a semiconductor material such as p-type gallium arsenide (p-GaAs) or the like. The insulating layer 114 functions as a current confining layer, and is made of an insulating material such as silicon oxide (SiO₂) or the like.

The n-type cladding layer 112n is a layer that produces a confinement effect of light or carriers (electrons), and is made of a semiconductor material made of n-type aluminum gallium arsenide (n-AlGaAs) or the like. Meanwhile, the p-type cladding layer 112p is a layer that produces a confinement effect of light or carriers (holes), and is made of a semiconductor material made of p-type aluminum gallium arsenide (p-AlGaAs) or the like. In addition to these materials, InGaN-based semiconductor materials, CdZnMgSSe-based semiconductor materials, or other suitable semiconductor materials may be used.

The active layer 113 is a layer from which laser light L0 is to be emitted, and is made of a semiconductor material such as gallium arsenide (GaAs), InGaN, CdSe, or the like.

In the semiconductor laser configured above, the laser light (TE polarized laser light) L0 that is strongly polarized along the in-plane direction in the DH structure (in this case, the polarization direction is along an X axis) is emitted from the active layer 113. This laser light L0 has a far filed pattern (FFP) whose major and minor axes are along the Z and X axes, respectively.

### (Optical Members)

The light guide plate 122 is an optical member that leads the laser light L0 incident from the laser light source 11 to the light modulation element 14 (and the light emitting layer 15).

The reflection plate 121 is an optical member that reflects the laser light L0 that would be emitted from the light guide plate 122 to the external through the back surface (a surface on the opposite side of the light modulation element 14), thereby returning the laser light L0 toward the light modulation element 14.

The diffuser plate 123 is an optical member that scatters the laser light L0 having been emitted from the light guide plate 122 toward the light modulation element 14, thereby suppressing the in-plane non-uniformity of the luminance of the laser light L0.

### (Light Modulation Element 14)

The light modulation element 14 is an element that has a function of modulating the laser light L0 incident from the diffuser plate 123 for each of pixels (red pixels 10R, green pixels 10R, and blue pixels 10R in this case), and is configured by a liquid crystal element, as an example, in this embodiment.

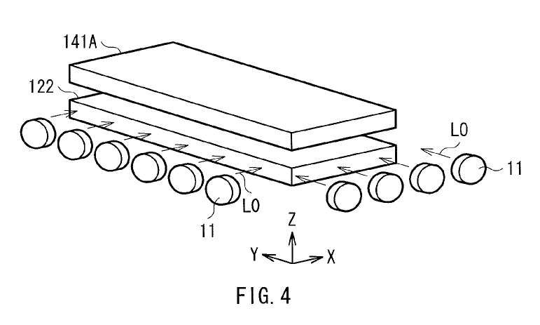

FIG. 3 is a schematic cross sectional view illustrating an exemplified, detailed configuration of the light modulation element 14 composed of a liquid crystal element. In this liquid crystal element, an incident side polarization plate 141A, a substrate 140A, a pixel electrode 142A, a liquid crystal layer 143, a common electrode 142B, a substrate 140B, and an output side polarization plate 141B are stacked along a Z axis illustrated in FIG. 3 in this order from the light incident side (the side of the diffuser plate 123) to the light output side (the side of the light emitting layer 15).

Each of the substrates 140A and 140B (a pair of substrates that oppose each other) is a substrate having a light transmitting property, and is configured by, for example, a glass substrate. Of these substrates, the substrate 140A has elements, such as thin-film transistors (TFTs) and the like, and wires (both not illustrated) formed therein.

Each of the incident side polarization plate 141A and the output side polarization plate 141B is an optical element that has a function of selectively allowing a specific polarization component contained in incident light to pass therethrough, but absorbing other polarization components therein. The incident side polarization plate 141A and the output side polarization plate 141B are arranged such that the respective light transmitting axes (polarization axes) thereof are orthogonal to each other (constituting the crossed Nichol arrangement), or are parallel to each other (constituting the parallel Nichol arrangement). In the example illustrated in FIG. 3, for example, a polarization axis P21 of the incident side polarization plate 141A is aligned with an X axis, whereas a polarization axis P22 of the output side polarization plate 141B is aligned with a Y axis, in order to constitute the crossed Nichol.

The pixel electrode 142A is individual electrodes formed for each of the pixels (or the red pixels 10R, the green pixels 10R, and the blue pixels 10R). Meanwhile, the common electrode 142B is an electrode formed entirely on the substrate 140B so as to be shared by the individual pixels.

The liquid crystal layer 143 is interposed (and sealed) between the substrates 140A and 140B (or between the pixel electrode 142A and the common electrode 142B), and may be configured by any of various liquid crystal materials.

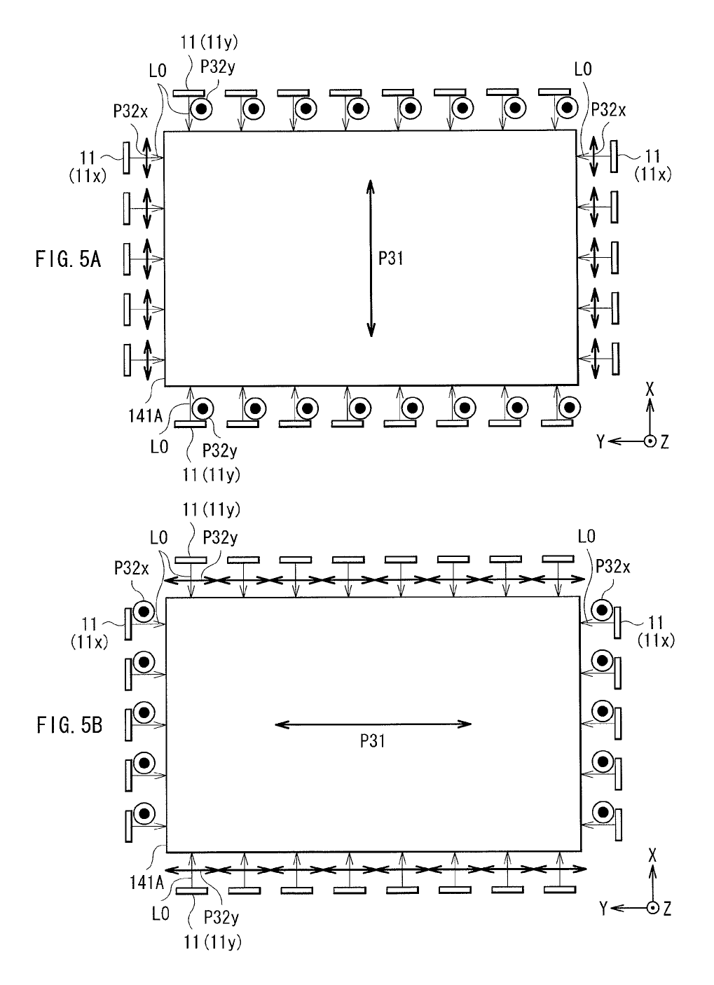

In this embodiment, for example, each of the incident side polarization plate 141A, the light guide plate 122, and the like has a rectangular shape whose long and short sides extend along a Y axis and an X axis, respectively, as illustrated in FIG. 4. In addition, a plurality of laser light sources 11 are arrayed on each side of the rectangular light guide plate 122. The laser light sources 11 and the incident side polarization plate 141A are arranged such that the polarization direction of the laser light L0 emitted from each laser light source 11 is substantially aligned (desirably aligned) with the polarization axis (light transmitting axis) of the incident side polarization plate 141A, as will be described in detail hereinafter.

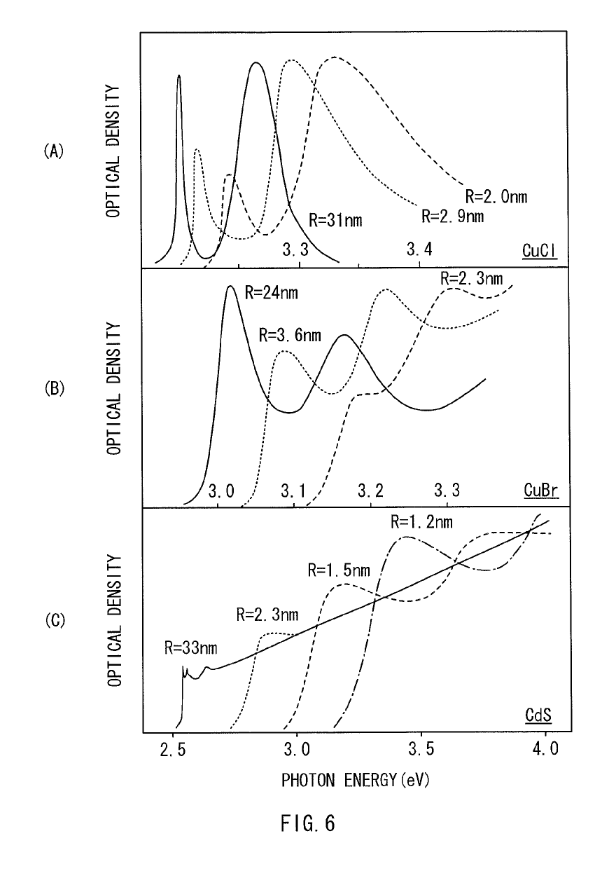

Specifically, in an example illustrated in FIG. 5A, a polarization direction P32x of the laser light L0 that is emitted from each of a plurality of laser light sources 11x arranged along an X axis parallel to the short side is along the X axis. In addition, a polarization direction P32y of the laser light L0 that is emitted from each of a plurality of laser light sources 11y arranged along a Y axis parallel to the long side is along a Z axis. Furthermore, a polarization axis (light transmitting axis) P31 of the incident side polarization plate 141A is aligned with the X axis (and the Z axis).

Meanwhile, in an example illustrated in FIG. 5B, the polarization direction P32x of the laser light L0 that is emitted from each of the plurality of laser light sources 11x arranged along the X axis parallel to the short side is along the Z axis. In addition, the polarization direction P32y of the laser light L0 that is emitted from each of the plurality of laser light sources 11y arranged along the Y axis parallel to the long side is along the Y axis. Furthermore, the polarization axis (light transmitting axis) P31 of the incident side polarization plate 141A is aligned with the Y axis (and the Z axis).

### (Driver Section 16)

The driver section 16 controls an operation (light modulating operation) of the light modulation element 14 (or drives the light modulation element 14). Concretely, for example, when the light modulation element 14 is composed of the liquid crystal element configured above, the driver section 16 applies a voltage between the pixel electrode 142A and the common electrode 142B in accordance with an image signal for each pixel, thereby controlling the light modulating operation for each pixel. In this way, the light modulation element 14 composed of the liquid crystal element performs the light modulating operation for each of the pixels (or the red pixels 10R, the green pixels 10R, and the blue pixels 10R).

### (Light Emitting Layer 15)

The light emitting layer 15 is configured by forming quantum dots in a resin material such as polystyrene or the like, and is a layer that emits emission light (display light) of a certain color for each of the pixels (or the red pixels 10R, the green pixels 10R, and the blue pixels 10R), on the basis of each laser light (each excitation light) L0 emitted from the light modulation element 14. In this embodiment, the light emitting layer 15 includes red light emitting layers 15R, green light emitting layers 15G, and blue light emitting layers 15B disposed in the red pixels 10R, the green pixels 10G, and the blue pixels 10B, respectively. In other words, the light emitting layer 15 includes multi-colored light emitting layers (or the red light emitting layers 15R, the green light emitting layers 15G, and the blue light emitting layers 15B) which are color-coded corresponding to the red pixels 10R, the green pixels 10G, and the blue pixels 10B. In addition, the quantum dots in the multi-colored light emitting layers are configured to generate emission light beams whose wavelengths (colors) differ from one another (or red, green, and blue emission light beams), on the basis of the corresponding excitation lights L0.

Examples of a material of these quantum dots include CdSe, CdS, ZnS:Mn, InN, InP, CuCl, CuBr, and Si, and the particle diameter (or the size of one side) of each quantum dot is, for example, approximately 2 nm to 20 nm. Among the materials of the quantum dots, InP or the like is given as an example of red light emitting material, CdSe or the like is given as an example of green light emitting material, and CdS or the like is given as an example of blue light emitting material.

The wavelength (corresponding to the photon energy) of each light emitted from the above light emitting layer 15 are varied by changing a size (particle diameters) R or a material composition of each quantum dot, for example, as depicted in Parts (A) to (C) of FIG. 6. This enables the red light emitting layers 15R, the green light emitting layers 15G, and the blue light emitting layers 15B to generate emission light beams of different wavelengths (colors) (or red, green, and blue emission light beams, respectively).

In this embodiment, the quantum dots contained in the light emitting layer 15 (or the red light emitting layers 15R, the green light emitting layers 15G, and the blue light emitting layers 15B) are configured to generate emission light whose wavelength is longer than that of the excitation light L0, on the basis of the excitation light (laser light) L0. In other words, the quantum dots make a wavelength conversion from the excitation light L0 of a relatively short wavelength to the emission light of a relatively long wavelength. Consequently, a wavelength conversion is made from the excitation light L0 to the emission light with a simple configuration, as will be described in detail hereinafter.

### Method of Manufacturing Display Device 1

The above display device 1 may be manufactured by, for example, the following processing. First, the light source section that emits the excitation light (laser light) L0 for each pixel is formed by using the laser light sources 11, the reflection plate 121, the light guide plate 122, the diffuser plate 123, and the light modulation element 14. Specifically, semiconductor lasers having the DH structure, for example, illustrated in FIG. 2 are formed by employing, for example, the photolithographic technique, so that the laser light sources 11 are fabricated. Then, the reflection plate 121, the light guide plate 122, and the diffuser plate 123, which have the above-described configurations, are bonded to one another in this order, so that the optical members in the light source section are formed. Subsequently, the laser light sources 11 are arranged on the respective sides of the optical members (light guide plate 122), and in turn, the light modulation element 14 is bonded to the top surface of the diffuser plate 123, so that the above light source section is fabricated.

In this case, for example, when being composed of the liquid crystal element having the configuration illustrated in FIG. 3, the light modulation element 14 is formed by, for example, the following processing. First, the substrate 140A which serves as a TFT substrate, and the substrate 140B are formed individually by using glass substrates and the like. Then, the pixel electrodes 142A and the incident side polarization plate 141A are formed on the respective surfaces of the substrate 140A. Meanwhile, the common electrode 142B and the output side polarization plate 141B are formed on the respective surfaces of the substrate 140B. Subsequently, while the substrates 140A and 140B are arranged such that the pixel electrode 142A and the common electrode 142B oppose each other, liquid crystal is injected into a space defined by the substrates 140A and 140B, so that the liquid crystal layer 143 is formed. Consequently, the light modulation element 14 composed of the liquid crystal element illustrated in FIG. 3 is formed.

Next, the light emitting layer 15 is formed on the top surface of the light modulation element 14 by using quantum dots. Specifically, the quantum dots are mixed into the above-mentioned resin material or the like while the above material and size (particle diameter) of the quantum dots are controlled. Then, the mixtures are applied to the light modulation element 14 independently of each of the pixels (or the red pixels 10R, the green pixels 10G, and the blue pixels 10B). In this case, note that the quantum dots are formed so as to generate the emission light of a wavelength longer than that of the excitation light L0, on the basis of the excitation light L0, as described above. Consequently, the light emitting layer 15 (or the red light emitting layers 15R, the green light emitting layers 15G, and the blue light emitting layers 15B) is formed on the light modulation element 14. Through the above processing, the display device 1 illustrated in FIG. 1 is completed.

### Functional Effect of Display Device 1

### (1. Basic Operation)

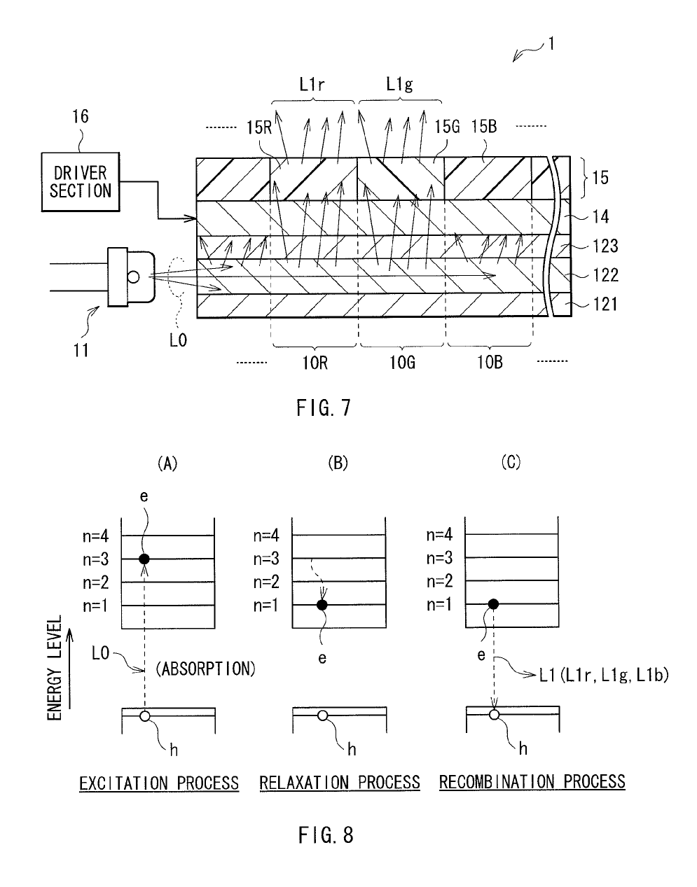

In the above display device 1, the laser light L0 is emitted, as the excitation light, from the light source section (or the laser light source 11, the reflection plate 121, the light guide plate 122, the diffuser plate 123, and the light modulation element 14) for each of the pixels (or the red pixels 10R, the green pixels 10G, and the blue pixels 10B), for example, as illustrated in FIG. 7. On the basis of this excitation light L0, emission light L1 (red emission light L1r, green emission light L1g, or blue emission light L1b) is emitted from the light emitting layer 15 containing the quantum dots for each pixel.

In more detail, the laser light (excitation light) L0 emitted from the laser light source 11 enters the light modulation element 14 through the light guide plate 122, the reflection plate 121, and the diffuser plate 123. The laser light L0 is modulated in this light modulation element 14 for each pixel, and then, the modulated light L0 is emitted to the light emitting layer 15. In this way, the luminance of the excitation light L0 emitted to the light emitting layer 15 is controlled for each pixel. For example, referring to an example illustrated in FIG. 7, in a red pixel 10R and a green pixel 10G, the modulated excitation light L0 is emitted from the light modulation element 14 to the red light emitting layer 15R and the green light emitting layer 15G. As a result, red emission light L1r and green emission light L1g are emitted from the red light emitting layer 15R and the green light emitting layer 15G, respectively. Meanwhile, in the blue pixel 15B, the modulated excitation light L0 is not emitted from the light modulation element 14 to the blue light emitting layer 15B, and blue emission light L1b is not emitted as a result. In the above manner, an image is displayed by the display device 1.

The above display device 1 that uses the laser light (excitation light) L0 and the light emitting layer 15 containing the quantum dots provides, for example, the following advantages, in comparison with an existing, typical liquid crystal display device. The excitation light L0 is coupled to the light guide plate 122 efficiently, due to the directivity of the laser light L0, and any color filter is unnecessary. This decreases the optical loss, thereby improving the display luminance and achieving the low power consumption. In addition, the viewing angle property is improved (or the viewing angle dependency is suppressed), due to the merit of the self-light emitting type display device. Furthermore, since it is possible for the laser light L0 be driven with a short pulse, and quantum dots have a short fluorescence lifetime, a high speed operation, such as an operation at several nanoseconds to several hundred microseconds is realized. In addition, this high speed operation enhances a property of reproducing a moving image. For example, even when the display device 1 is applied to a 3D display device employing a time division type, the display device 1 also exhibits the excellent moving image reproduction property. Moreover, the laser light source L0 is used as the excitation light, and therefore, the spectrum of the emission light L1 (the red emission light L1r, the green red emission light L1g, or the blue red emission light L1b) has a narrow full width at half maximum (FWHM). This realizes display of the wide color gamut (or a display device having the high color reproducibility).

### (2. Function)

In this embodiment, in performing a display operation as described above, the quantum dots contained in the light emitting layer 15 generate the emission light L1 whose wavelength is longer than the excitation light L0, on the basis of the excitation light L0. In more detail, the quantum dots contained in each red light emitting layer 15R generate the red emission light L1r of a relatively long wavelength, on the basis of the excitation light L0 of a relatively short wavelength (or make a wavelength conversion from the excitation light L0 to the red emission light L1r). The quantum dots contained in each green light emitting layer 15G generate the green emission light L1g of a relatively long wavelength, on the basis of the excitation light L0 of a relatively short wavelength (or make a wavelength conversion from the excitation light L0 to the green emission light L1g). The quantum dots contained in each blue light emitting layer 15B generate the blue emission light L1b of a relatively long wavelength, on the basis of the excitation light L0 of a relatively short wavelength (or make a wavelength conversion from the excitation light L0 to the blue emission light L1b).

In this embodiment, as a result of the above function, the wavelength conversion is made from the excitation light L0 to the emission light L1 with a simpler configuration, for example, in comparison with, rather, a case where a wavelength conversion is made from excitation light of a longer wavelength to emission light of a shorter wavelength (a wavelength conversion is made employing, for example, a second harmonic generation (SHG)), and the like.

Here, before explaining a detailed operation of generating the emission light L1 with the quantum dots (or a detailed operation of a wavelength conversion from the excitation light L0 to the emission light L1) as described above, a description will be given of a principle of an electron energy transition regarding quantum dots.

First, with regard to the movement of a free electron in a one-dimensional region which is confined within an excessively small area like a quantum dot, a potential energy “U” of the free electron is 0 (U=0). Accordingly, the Schrodinger expression is given by the following expression (1).

E·ψ=−h²/(8π²m)·(nabla)²ψ (1)

In this case, a wave function and electron energy that satisfy this expression are given by expressions (2) and (3), respectively.

Wave function:ψ=A·sin(nπx/L)(n: an integer of equal to or more than 1) (2)

Electron energy:Eₙ=(nh)²/(8 mL²)(n: an integer of equal to or more than 1) (3)

(A: a constant of the amplitude of a standing wave, L: the size of a quantum dot, n: a principal quantum number, x: the position of an electron (0<x<L), h: a Planck's constant, and m: the effective mass of an electron)

As described above, “n” denotes the principal quantum number, and is an integer of other than 1 (equal to or more than 1). Therefore, the energy of such an electron has the following property.

(A) The energy of an electron is determined by the size of a region in which an electron is confined, and is inversely proportional to the square of the size.
(B) The energy of an electron is not changed continuously, but discretely in accordance with the principal quantum number.

With regard to the change (transition) in the energy of an electron confined within a quantum dot, as is evident from (A), the energy of an electron within a quantum dot is determined by fabricating the quantum dot of a preset size. In addition, as is evident from (B), the energy of an electron within the quantum dot is changed discretely, and therefore, the absorption energy of light is also discrete.

In accordance with the above principle, each quantum dot contained in the light emitting layer 15 according to this embodiment performs an operation of generating the emission light L1 (or an operation of the wavelength conversion from the excitation light L0 to the emission light L1) by undergoing processes, concretely, such as those illustrated in Parts (A) to (C) of FIG. 8.

Specifically, first, during an excitation process illustrated in Part (A) of FIG. 8, an electron “e” that is positioned in the valence band is excited to a quantum level having a principal quantum number “n” of equal to or more than 2 (n≧2) (in this case, for example, n=3) in the conduction band, by obtaining the energy of the excitation light L0. Note that in this case, a hole “h” is positioned on the original quantum level in the valence band. Subsequently, during a relaxation process illustrated in Part (B) of FIG. 8, the electron “e” that has been excited to the quantum level having a principal quantum number “n” of equal to or more than 2 (n≧2) (in this case, for example, n=3) in the excitation process is relaxed to a quantum level having a principal quantum number “n” of 1 (n=1) called the ground state. Finally, during a recombination process illustrated in Part (C) of FIG. 8, the emission light L1 (L1r, L1g, or L1b) of a wavelength which corresponds to the difference in energy between the quantum level having a principal quantum number “n” of 1 (n=1) and the quantum level in the valence band (the wavelength longer than that of the excitation light L0) is emitted.

In this case, it is preferable for the difference in energy between the quantum level having a principal quantum number “n” of equal to/more than 2 (n≧2) and the quantum level in the valence band during the excitation process to be substantially equal (desirably, equal) to the energy of the excitation light L0 (for example, so as to fall within a wavelength range of ±10 nm). This is because, in this case, the absorption rate, especially for the excitation light L0, of the light emitting layer 15 containing the quantum dots increases, so that the emission light of high luminance is realized, even when the light emitting layer 15 is formed of a thin film. In view of this, it can be said that using laser light having an extremely narrow wavelength range as the excitation light L0 is desirable as in this embodiment.

In Example illustrated in Parts (A) to (C) of FIG. 9, CdS having a particle diameter (size) R of 6.0 nm (R=6.0 nm) is used as quantum dots in the blue light emitting layer 15B (see Part (A)), CdSe having a particle diameter R of 4.3 nm (R=4.3 nm) is used as quantum dots in the green light emitting layer 15G (see Part (B)), and InP having a particle diameter R of 4.8 nm (R=4.8 nm) is used as quantum dots in the red light emitting layer 15R (see Part (C)). Note that in this case, since it is assumed the case where there is no difference among the particle diameters R of the quantum dots, the absorption spectrum of each quantum dot is a line spectrum. In Example illustrated in each of Parts (A) to (C) of FIG. 9, a wavelength “λ” is 420 nm (λ=420 nm) (or falls within the wavelength range of a blue-violet color), at the principal quantum number “n” of 2 (n=2). Meanwhile, in Part (A) of FIG. 9, a wavelength “λ” is 461 nm (λ=461 nm) (or falls within the wavelength range of blue light), at the principal quantum number “n” is 1 (n=1). Likewise, in Part (B) of FIG. 9, a wavelength “λ” is 571 nm (λ=571 nm) (or falls within the wavelength range of green light), and in Part (C) of FIG. 9, a wavelength “λ” is 641 nm (λ=641 nm) (or falls within the wavelength range of red light). Thus, Example demonstrates that the quantum dots in each red light emitting layer 15R generate the red emission light L1r having a wavelength “λ” of 641 nm (λ=641 nm), on the basis of the excitation light L0 having a wavelength “λ” of 420 nm (λ=420 nm). Likewise, the quantum dots in each green light emitting layer 15G generate the green emission light L1g having a wavelength “λ” of 571 nm (λ=571 nm), on the basis of the excitation light L0 having a wavelength “λ” of 420 nm (λ=420 nm). Moreover, the quantum dots in each blue light emitting layer 15B generate the blue emission light L1b having a wavelength “λ” of 461 nm (λ=461 nm), on the basis of the excitation light L0 having a wavelength “λ” of 420 nm (λ=420 nm). In other words, Example demonstrates that the light emitting layer 15 generates the red emission light L1r, the green emission light L1g, and the blue emission light L1b efficiently for the corresponding pixels, on the basis of the excitation light L0 having a single wavelength.

Consequently, in Example, the spectrum of each of the red emission light L1r, the green emission light L1g, and the blue emission light L1b exhibits a high emission intensity (or high luminance) and a narrow FWHM, for example, as illustrated in Part (A) of FIG. 10. Specifically, Example provides an integral intensity that is approximately two and a half times as high as Comparative example illustrated in Part (B) of FIG. 10 (which is an example of a liquid crystal display device equipped with color filters and a white light emitting diodes (LED) producing white light by exciting a yellow (Ye) fluorescent substance using blue light). Consequently, the emission spectrum of such a narrow FWHM makes color representation brighter, and expands a color range composed of the three primary colors (R, G, and B), thus leading to better color reproducibility.

In contrast, in Comparative example illustrated in Part (B) of FIG. 10, the white LED configured above causes an optical loss of, for example, approximately 15% of original blue light, and the yellow fluorescent substance absorbs the remaining light that corresponds to approximately 85% of the blue light, then generating yellow light with a quantum efficiency of 70%. In this case, each of white light emitted from the white LED and the R, G, and B lights generated by the while light passing through corresponding color filters has an optical spectrum that has extremely lower luminance and a wider FWHM, in comparison with the above Example. Furthermore, at this time, it is obvious that prominent optical loss occur in the optical spectrums of the individual color lights, in comparison with the integral intensity of light emitted from the blue LED contained in the white LED.

As described above, in this embodiment, the quantum dots included in the light emitting layer 15 (or the red light emitting layers 15R, the green light emitting layers 15G, and the blue light emitting layer 15B) generate the emission light L1 (L1r, L1g, and L1b) whose wavelength is longer than the excitation light L0, on the basis of the excitation light L0. This achieves a wavelength conversion from the excitation light L0 to the emission light L1 with a simple configuration. Therefore, it is possible to facilitate the improvement of the utilization efficiency of light.

Moreover, the polarization direction of the laser light L0 emitted from the laser light source 11 is substantially aligned with the polarization axis (light transmitting axis) of the incident side polarization plate 141A. This increases the light transmission factor of the incident side polarization plate 141A, thus decreasing the optical loss. Consequently, the quantum dots contained in the light emitting layer 15 which the excitation light L0 is to enter after entering the incident side polarization plate 141A generates the emission light L1 efficiently. This enables the display device 1 to exhibit a higher luminance and lower power consumption.

### Application Examples

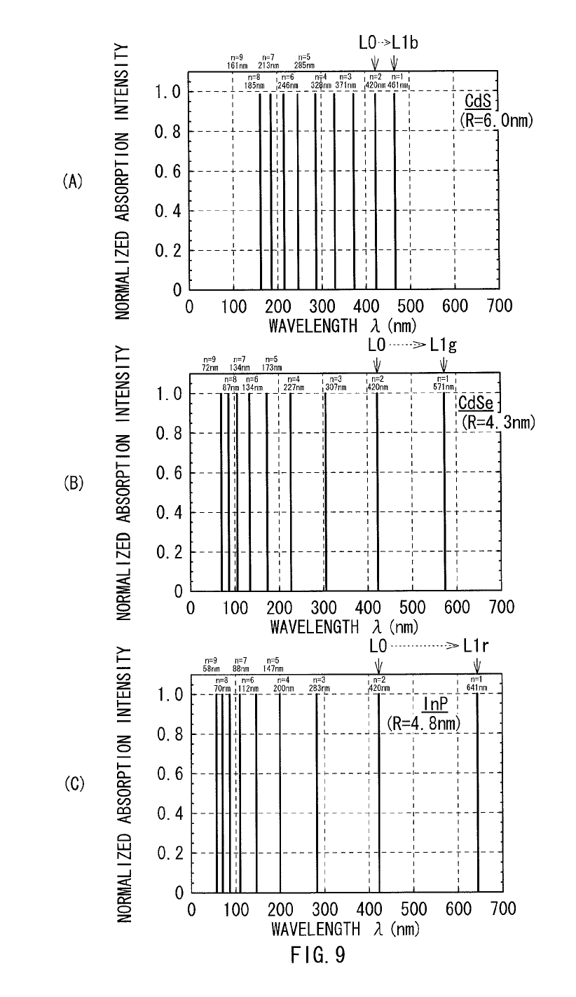

Next, a description will be given of application examples of the above display device according to the embodiment, with reference to FIGS. 11 to 15G. The above display device according to the embodiment is applicable to electronic apparatuses in various fields, including TV units, digital cameras, notebook personal computers, portable terminal devices such as portable phones and the like, and video cameras. In other words, this display device is applicable to electronic apparatuses in various fields which display an image, on the basis of an image signal that has been input from an external source or generated internally.

### Application Example 1

FIG. 11 illustrates the appearance of a TV unit to which the above display device is applied. This TV unit is equipped with, for example, an image display screen section 510 including a front panel 511 and a filter glass 512, and this image display screen section 510 is constituted by the above display device.

### Application Example 2

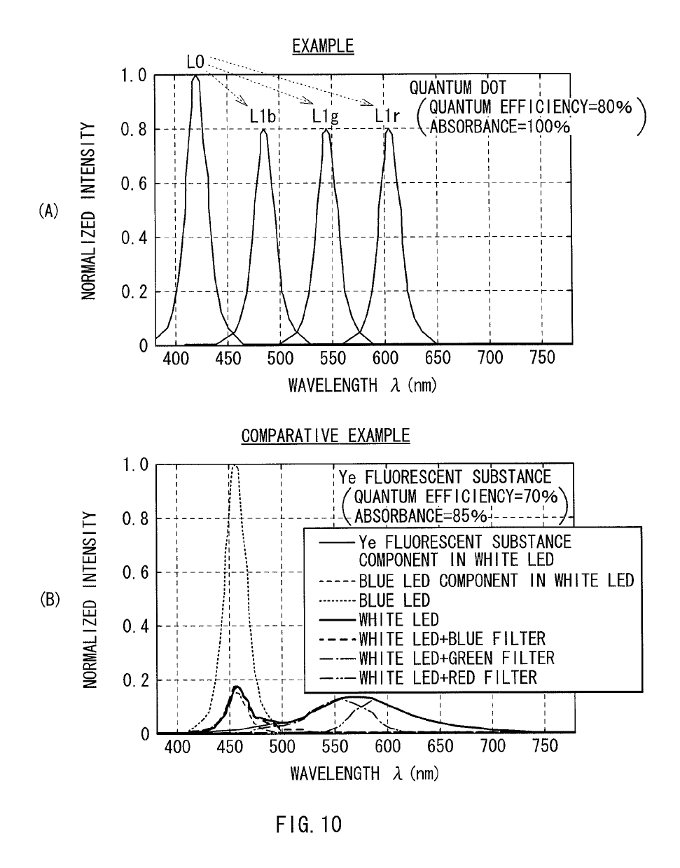

FIGS. 12A and 12B illustrate the appearance of a digital camera to which the above display device is applied. This digital camera includes, for example, a light emitting section 521 for a flash, a display section 522, a menu switch 523, and a shutter button 524, and this display section 522 is constituted by the above display device.

### Application Example 3

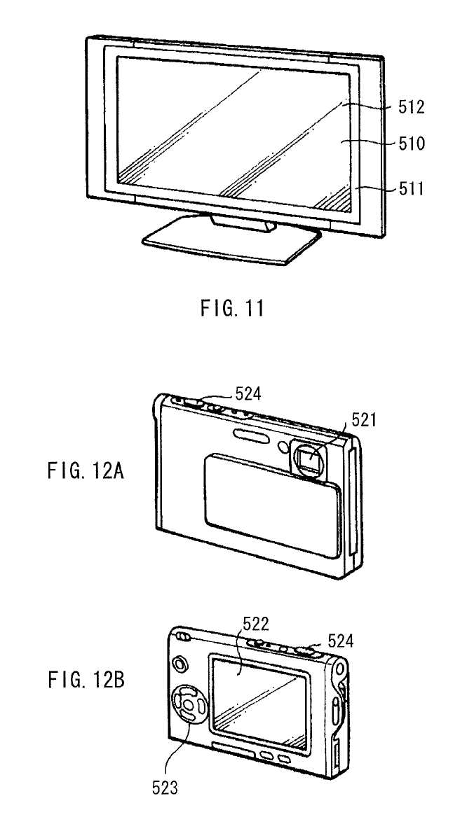

FIG. 13 illustrates the appearance of a notebook personal computer to which the above display device is applied. This notebook personal computer includes, for example, a main unit 531, a keyboard 532 that is used to perform an input operation of letters, characters, and the like, and a display section 533 that displays an image, and this display section 533 is constituted by the above display device.

### Application Example 4

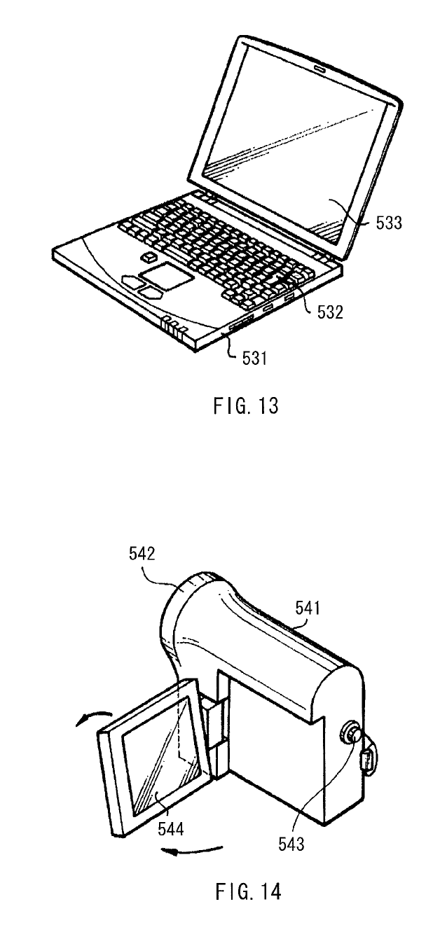

FIG. 14 illustrates the appearance of a video camera to which the above display device is applied. This video camera includes, for example, a main unit 541, a subject capturing lens 542 provided at a forward location on a side surface of this main unit 541, a capturing start/stop switch 543, and a display section 544. This display section 544 is constituted by the above display device.

### Application Example 5

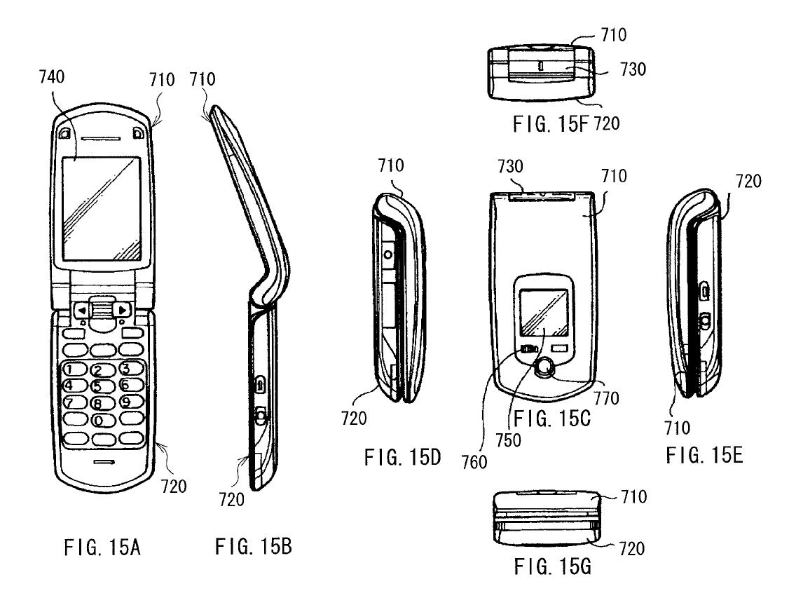

FIGS. 15A to 15G illustrate the appearance of a portable phone to which the above display device is applied. This portable phone is configured by, for example, connecting an upper casing 710 and a lower casing 720 with a connection portion (hinge portion) 730, and includes, for example, a display 740, a sub-display 750, a picture light 760, and a camera 770. One or both of the display 740 and the sub-display 750 are constituted by the display device.

### Modification Examples

Up to this point, the technique according to an embodiment of the present disclosure has been described by giving the embodiment and the application examples. However, the technique according to an embodiment of the present disclosure is not limited to this embodiment and the like, and various modifications are possible.

For example, in the above embodiment and the like, the cases have been described, where the light emitting layer is composed of multi-colored light emitting layers that are color-coded for each pixel, and the quantum dots in the individual multi-colored light emitting layers generate emission light beams of different wavelengths, on the basis of the excitation light. However, the technique according to an embodiment of the present disclosure is not limited to these cases. Specifically, this technique is also applicable to the case where the light emitting layer is composed of single-colored light emitting layers.

In the above embodiment and the like, the case has been described, where the light source section that emits the excitation light for each pixel is configured by the laser light sources (semiconductor lasers or the like) and the light modulation element (liquid crystal element and the like). However, the configuration of the light source section is not limited thereto, but may be another one.

For example, the laser light source is not limited to a semiconductor laser, but a laser light source of another type may be used instead. Specifically, for example, an Ar⁺ gas laser source (having an oscillation wavelength of 457 nm) may be used. In addition, laser light emitted from a semiconductor or gas laser light source may be subjected to a wavelength conversion by using a second harmonic generator (SHG), so that light of a shorter wavelength is generated and used as the excitation light. In this case, for example, an AlGaAs semiconductor laser (having an oscillation wavelength of 840 nm) and a SHG made of LiNbO₃ may be used to generate the excitation light having a wavelength of approximately 420 nm.

The light source may not be a laser light source, as long as a light source emits the excitation light. However, using a laser light source, which emits the excitation light having a narrow FWHM and high directivity, is considered to be more desirable. This is because such laser light is absorbed more readily into each quantum dot having a narrow absorption wavelength range, and is coupled more efficiently to the light guide plate.

The configuration of the light modulation element composed of a liquid crystal element is not limited to that described in the above embodiment, but may be another one. For example, the incident side polarization plate 141A may not be provided, and therefore, only the output side polarization plate 141B may be used. This is because, for example, when the laser light is used as the excitation light, it is possible to decrease the optical loss to a certain extent without using the incident side polarization plate, due to the strongly polarized nature of the laser light. In addition, the light modulation element may be any light modulation element other than a liquid crystal element.

Accordingly, it is possible to achieve at least the following configurations from the above-described example embodiments, the application examples, and the modifications of the disclosure.

(1) A display device, including:

a light source section emitting excitation light for each pixel; and

a light emitting layer including a quantum dot and emitting emission light for each of the pixels, the quantum dot generating, based on the excitation light, the emission light having a wavelength longer than a wavelength of the excitation light.

(2) The display device according to (1), wherein, in the quantum dot:

during an excitation, an electron positioned in a valence band is excited to a quantum level having a principal quantum number of equal to or more than two in a conduction band, by obtaining energy of the excitation light;

during a relaxation, the electron having been excited to the quantum level having the principal quantum number of equal to or more than two is relaxed to an quantum level having a principal quantum number of one; and

during a recombination, the emission light of the longer wavelength is emitted that corresponds to a difference in energy between the quantum level having the principal quantum number of one and the quantum level in the valence band.

(3) The display device according to (2), wherein the difference in energy between the quantum level having the principal quantum number of equal to or more than two and the quantum level in the valence band is substantially equal to the energy of the excitation light.
(4) The display device according to any one of (1) to (3), wherein the light source section includes:

a laser light source emitting laser light as the excitation light; and

a light modulation element modulating the laser light for each of the pixels.

(5) The display device according to (4), wherein the light modulation element includes a liquid crystal element, and the liquid crystal element includes:

a pair of substrates that are opposed to each other;

a liquid crystal layer interposed and sealed between the pair of substrates;

an incident side polarization plate disposed on a substrate of the pair of substrates that is closer to the laser light source; and

an output side polarization plate disposed on a substrate of the pair of substrates that is closer to the light emitting layer.

(6) The display device according to (5), wherein a polarization direction of the laser light is substantially aligned with a polarization axis of the incident side polarization plate.
(7) The display device according to any one of (4) to (6), wherein the laser light source includes a semiconductor laser.
(8) The display device according to any one of (1) to (7), wherein

the light emitting layer includes multi-colored light emitting layers that are color-coded for each of the pixels, and

the quantum dot in each of the multi-colored light emitting layers generates, based on the excitation light, the emission light having the wavelength that is different between the multi-colored light emitting layers.

(9) An electronic apparatus with a display device, the display device including:

a light source section emitting excitation light for each pixel; and

a light emitting layer including a quantum dot and emitting emission light for each of the pixels, the quantum dot generating, based on the excitation light, the emission light having a wavelength longer than a wavelength of the excitation light.

(10) The electronic apparatus according to (9), wherein, in the quantum dot:

during an excitation, an electron positioned in a valence band is excited to a quantum level having a principal quantum number of equal to or more than two in a conduction band, by obtaining energy of the excitation light;

during a relaxation, the electron having been excited to the quantum level having the principal quantum number of equal to or more than two is relaxed to an quantum level having a principal quantum number of one; and

during a recombination, the emission light of the longer wavelength is emitted that corresponds to a difference in energy between the quantum level having the principal quantum number of one and the quantum level in the valence band.

(11) The electronic apparatus according to (10), wherein the difference in energy between the quantum level having the principal quantum number of equal to or more than two and the quantum level in the valence band is substantially equal to the energy of the excitation light.
(12) The electronic apparatus according to any one of (9) to (11), wherein the light source section includes:

a laser light source emitting laser light as the excitation light; and

a light modulation element modulating the laser light for each of the pixels.

(13) The electronic apparatus according to (12), wherein the light modulation element includes a liquid crystal element, and the liquid crystal element includes:

a pair of substrates that are opposed to each other;

a liquid crystal layer interposed and sealed between the pair of substrates;

an incident side polarization plate disposed on a substrate of the pair of substrates that is closer to the laser light source; and

an output side polarization plate disposed on a substrate of the pair of substrates that is closer to the light emitting layer.

(14) The electronic apparatus according to (13), wherein a polarization direction of the laser light is substantially aligned with a polarization axis of the incident side polarization plate.
(15) The electronic apparatus according to any one of (12) to (14), wherein the laser light source includes a semiconductor laser.
(16) The electronic apparatus according to any one of (9) to (15), wherein

the light emitting layer includes multi-colored light emitting layers that are color-coded for each of the pixels, and

the quantum dot in each of the multi-colored light emitting layers generates, based on the excitation light, the emission light having the wavelength that is different between the multi-colored light emitting layers.

(17) A method of manufacturing a display device, the method including:

forming a light source section that emits excitation light for each pixel; and

forming, using a quantum dot, a light emitting layer that emits emission light for each of the pixels, the quantum dot being configured to generate, based on the excitation light, the emission light having a wavelength longer than a wavelength of the excitation light.

(18) The method of manufacturing the display device according to (17), wherein, in the quantum dot:

during an excitation, an electron positioned in a valence band is excited to a quantum level having a principal quantum number of equal to or more than two in a conduction band, by obtaining energy of the excitation light;

during a relaxation, the electron having been excited to the quantum level having the principal quantum number of equal to or more than two is relaxed to an quantum level having a principal quantum number of one; and

during a recombination, the emission light of the longer wavelength is emitted that corresponds to a difference in energy between the quantum level having the principal quantum number of one and the quantum level in the valence band.

(19) The method of manufacturing the display device according to (18), wherein the difference in energy between the quantum level having the principal quantum number of equal to or more than two and the quantum level in the valence band is substantially equal to the energy of the excitation light.
(20) The method of manufacturing the display device according to any one of (17) to (19), wherein the forming the light source section includes:

forming a laser light source that emits laser light as the excitation light; and

forming a light modulation element that modulates the laser light for each of the pixels.

(21) The method of manufacturing the display device according to (20), wherein forming a liquid crystal element as the light modulation element includes:

forming a pair of substrates that are opposed to each other;

forming a liquid crystal layer interposed and sealed between the pair of substrates;

forming an incident side polarization plate disposed on a substrate of the pair of substrates that is closer to the laser light source; and

forming an output side polarization plate disposed on a substrate of the pair of substrates that is closer to the light emitting layer.

(22) The method of manufacturing the display device according to (21), wherein a polarization direction of the laser light is substantially aligned with a polarization axis of the incident side polarization plate.
(23) The method of manufacturing the display device according to any one of (20) to (22), wherein the laser light source includes a semiconductor laser.
(24) The method of manufacturing the display device according to any one of (17) to (23), wherein

the light emitting layer includes multi-colored light emitting layers that are color-coded for each of the pixels, and

the quantum dot in each of the multi-colored light emitting layers generates, based on the excitation light, the emission light having the wavelength that is different between the multi-colored light emitting layers.

The present disclosure contains subject matter related to that disclosed in Japanese Priority Patent Application JP 2011-172745 filed in the Japan Patent Office on Aug. 8, 2011, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A display device, comprising:
a light source section emitting excitation light for each pixel; and
a light emitting layer including a quantum dot and emitting emission light for each of the pixels, the quantum dot generating, based on the excitation light, the emission light having a wavelength longer than a wavelength of the excitation light.

2. The display device according to claim 1, wherein, in the quantum dot:
during an excitation, an electron positioned in a valence band is excited to a quantum level having a principal quantum number of equal to or more than two in a conduction band, by obtaining energy of the excitation light;
during a relaxation, the electron having been excited to the quantum level having the principal quantum number of equal to or more than two is relaxed to an quantum level having a principal quantum number of one; and
during a recombination, the emission light of the longer wavelength is emitted that corresponds to a difference in energy between the quantum level having the principal quantum number of one and the quantum level in the valence band.

3. The display device according to claim 2, wherein the difference in energy between the quantum level having the principal quantum number of equal to or more than two and the quantum level in the valence band is substantially equal to the energy of the excitation light.

4. The display device according to claim 1, wherein the light source section includes:
a laser light source emitting laser light as the excitation light; and
a light modulation element modulating the laser light for each of the pixels.

5. The display device according to claim 4, wherein the light modulation element includes a liquid crystal element, and the liquid crystal element includes:
a pair of substrates that are opposed to each other;
a liquid crystal layer interposed and sealed between the pair of substrates;
an incident side polarization plate disposed on a substrate of the pair of substrates that is closer to the laser light source; and
an output side polarization plate disposed on a substrate of the pair of substrates that is closer to the light emitting layer.

6. The display device according to claim 5, wherein a polarization direction of the laser light is substantially aligned with a polarization axis of the incident side polarization plate.

7. The display device according to claim 4, wherein the laser light source includes a semiconductor laser.

8. The display device according to claim 1, wherein
the light emitting layer includes multi-colored light emitting layers that are color-coded for each of the pixels, and
the quantum dot in each of the multi-colored light emitting layers generates, based on the excitation light, the emission light having the wavelength that is different between the multi-colored light emitting layers.

9. An electronic apparatus with a display device, the display device comprising:
a light source section emitting excitation light for each pixel; and
a light emitting layer including a quantum dot and emitting emission light for each of the pixels, the quantum dot generating, based on the excitation light, the emission light having a wavelength longer than a wavelength of the excitation light.

10. The electronic apparatus according to claim 9, wherein, in the quantum dot:
during an excitation, an electron positioned in a valence band is excited to a quantum level having a principal quantum number of equal to or more than two in a conduction band, by obtaining energy of the excitation light;
during a relaxation, the electron having been excited to the quantum level having the principal quantum number of equal to or more than two is relaxed to an quantum level having a principal quantum number of one; and
during a recombination, the emission light of the longer wavelength is emitted that corresponds to a difference in energy between the quantum level having the principal quantum number of one and the quantum level in the valence band.

11. The electronic apparatus according to claim 10, wherein the difference in energy between the quantum level having the principal quantum number of equal to or more than two and the quantum level in the valence band is substantially equal to the energy of the excitation light.

12. The electronic apparatus according to claim 9, wherein the light source section includes:
a laser light source emitting laser light as the excitation light; and
a light modulation element modulating the laser light for each of the pixels.

13. The electronic apparatus according to claim 12, wherein the light modulation element includes a liquid crystal element, and the liquid crystal element includes:
a pair of substrates that are opposed to each other;
a liquid crystal layer interposed and sealed between the pair of substrates;
an incident side polarization plate disposed on a substrate of the pair of substrates that is closer to the laser light source; and
an output side polarization plate disposed on a substrate of the pair of substrates that is closer to the light emitting layer.

14. The electronic apparatus according to claim 13, wherein a polarization direction of the laser light is substantially aligned with a polarization axis of the incident side polarization plate.

15. The electronic apparatus according to claim 12, wherein the laser light source includes a semiconductor laser.

16. The electronic apparatus according to claim 9, wherein
the light emitting layer includes multi-colored light emitting layers that are color-coded for each of the pixels, and
the quantum dot in each of the multi-colored light emitting layers generates, based on the excitation light, the emission light having the wavelength that is different between the multi-colored light emitting layers.

17. A method of manufacturing a display device, the method comprising:
forming a light source section that emits excitation light for each pixel; and
forming, using a quantum dot, a light emitting layer that emits emission light for each of the pixels, the quantum dot being configured to generate, based on the excitation light, the emission light having a wavelength longer than a wavelength of the excitation light.

18. The method of manufacturing the display device according to claim 17, wherein, in the quantum dot:
during an excitation, an electron positioned in a valence band is excited to a quantum level having a principal quantum number of equal to or more than two in a conduction band, by obtaining energy of the excitation light;
during a relaxation, the electron having been excited to the quantum level having the principal quantum number of equal to or more than two is relaxed to an quantum level having a principal quantum number of one; and
during a recombination, the emission light of the longer wavelength is emitted that corresponds to a difference in energy between the quantum level having the principal quantum number of one and the quantum level in the valence band.

19. The method of manufacturing the display device according to claim 18, wherein the difference in energy between the quantum level having the principal quantum number of equal to or more than two and the quantum level in the valence band is substantially equal to the energy of the excitation light.

20. The method of manufacturing the display device according to claim 17, wherein the forming the light source section includes:
forming a laser light source that emits laser light as the excitation light; and
forming a light modulation element that modulates the laser light for each of the pixels.
